(19) United States
(12) Patent Application Publication
(10) Pub. No.: US 2010/0058543 A1
(43) Pub. Date: Mar. 11, 2010

(54) WASHING MACHINE AND WASHING METHOD THEREFOR

(76) Inventors: Byung Keol Choi, Seoul (KR); Woo Young Kim, Seoul (KR); Han Gil Park, Seoul (KR); Jae Won Chang, Seoul (KR); Kyung Chul Woo, Seoul (KR)

Correspondence Address: KED & ASSOCIATES, LLP, P.O. Box 221200, Chantilly, VA, 20153-1200, US

(21) Appl. No.: 12/509,693

(22) Filed: Jul. 27, 2009

(30) Foreign Application Priority Data
Sep. 5, 2008 (KR) 10-2008-0087871

(51) Int. Cl. D06F 33/00; C11D 3/00

(52) U.S. Cl. 8/137; 68/12.01

(57) ABSTRACT

A washing machine and washing method therefor are provided. The washing method may include applying a first directional torque to a drum so that laundry in the drum is rotated in a first direction and lifted to a maximum height greater than half a height of the drum, braking the drum so that the laundry is dropped, applying a second directional torque to the drum so that the dropped laundry is rotated in a second direction and lifted to a maximum height greater than half a height of the drum, and braking the drum so that the laundry is dropped.

This application claims the benefit of Korean Patent Application No. 10-2008-0087871, filed in Korea on Sep. 5, 2008, which are hereby incorporated by reference for all purposes as if fully set forth herein.

### BACKGROUND

1. Field

A washing machine and washing method therefor are disclosed herein.

2. Background

Washing machines and washing methods are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a front perspective view of a washing machine in accordance with an embodiment;

FIG. 2 is a schematic diagram illustrating a washing method in accordance with an embodiment;

FIG. 3 is a diagram illustrating negative-phase braking in a washing method in accordance with an embodiment;

FIG. 4 is a diagram illustrating dynamic braking in a washing method in accordance with an embodiment; and

FIGS. 5A-5D are diagrams showing various motions created in a washing machine in accordance with an embodiment.

### DETAILED DESCRIPTION

Reference will now be made in detail to the embodiments, examples of which are illustrated in the accompanying drawings. Throughout the drawings, like elements are indicated using the same or similar reference designations where possible.

In general, a washing machine is a machine that removes dirt from items, such as clothing, bedding, etc. (hereinafter referred to as “laundry”) through washing, rinsing, and dehydrating cycles using a washing fluid, such as water, detergent, and mechanical operations. Washing machines are generally classified into an agitator type, a pulsator type, and a drum type washing machine.

The agitator type washing machine washes laundry by rotating a washing rod protruding from a center of a washing tub in left and right directions. The pulsator type washing machine washes laundry using frictional force generated between a fluid current and laundry by rotating a disk-shaped pulsator formed at a bottom of the washing tub in right and left directions. The drum type washing machine washes laundry by introducing a fluid, such as water, detergent, and laundry into a drum and rotating the drum.

The drum type washing machine may include a tub configured to contain wash fluid disposed within a cabinet forming an external appearance of the washing machine, a drum that accommodates laundry disposed within the tub, a motor that rotates the drum disposed at a rear side of the tub, and a drive shaft that extends from the motor to pass through the tub connected to a rear side of the drum. A lifter may be disposed within the drum to lift laundry during rotation of the drum.

The drum type washing machine may wash laundry in such a manner that the laundry is lifted by the lifter disposed within the drum, stuck to the drum during rotation of the drum, and then tumbled. However, a variety of washing methods may be required to improve the washing performance, in addition to the tumbling motion.

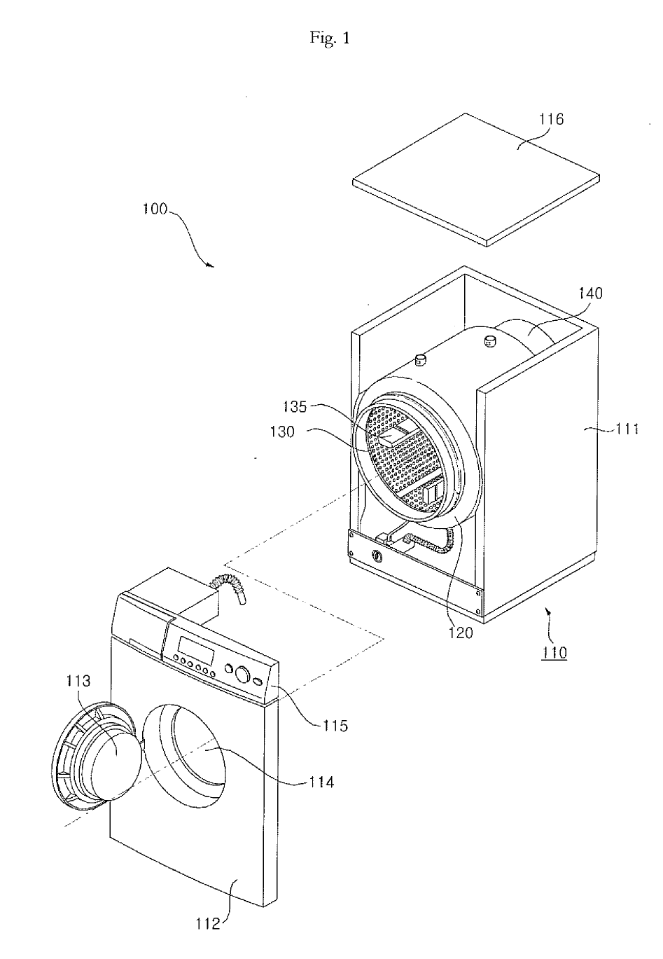

FIG. 1 is a front perspective view of a washing machine in accordance with an embodiment. The washing machine 100 of FIG. 1 may include a cabinet 110 that forms an external appearance of the washing machine 100, a tub 120 disposed within the cabinet 110 and supported thereby, a drum 130 rotatably disposed within the tub 120 configured to accommodate laundry to be washed, a driving device 140 that rotates the drum 122 by applying a torque thereto, and a controller 115 that controls the driving device 140.

The cabinet 110 may include a cabinet main body 111, a cabinet cover 112 disposed on a front side of the cabinet main body 111 and connected thereto, and a top plate 116 connected to the cabinet main body 111. The cabinet cover 112 may include a laundry inlet/outlet hole 114 formed to receive laundry therethrough, and a door 113 disposed to rotate so that the laundry inlet/outlet hole 114 may be opened and closed.

The tub 120 may be disposed within the cabinet 110 so as to be buffered by a spring (not shown) and a damper (not shown). The tub 120 may contain a wash fluid, such as water, during washing. The drum 130 may be rotatably disposed within the tub 120.

The drum 130 may include a plurality of holes through which the wash fluid may pass. A lifter 135 that lifts laundry to a predetermined height during rotation of the drum 130 may be disposed within the drum 130. The drum 130 may be rotated by the driving device 140.

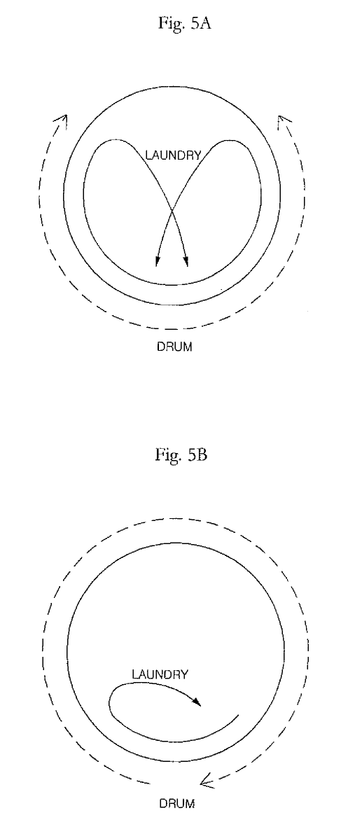

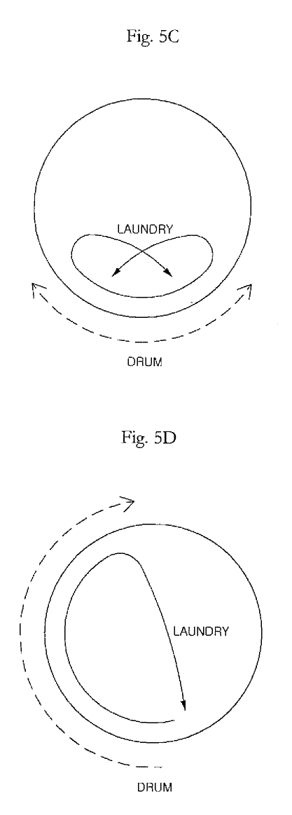

The driving device 140 may apply a torque or a braking force to the drum 130. The driving unit 140 may include a motor and a switching element that controls the same. The controller 115 may control the driving device 140 to provide various motions to the drum 130, as will be described later with respect to FIG. 5. For example, the drive device may apply a first directional torque to the drum 130 to rotate the drum 130 in a first direction. The first direction may be a forward or clockwise (CW) direction.

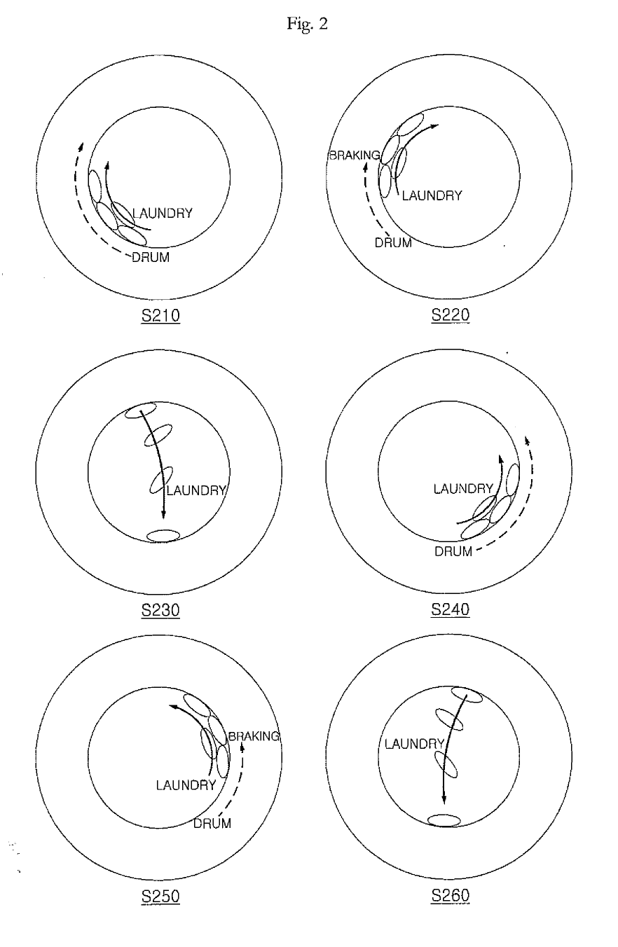

FIG. 2 is a schematic diagram illustrating a washing method in accordance with an embodiment. When the driving device 140 applies a first directional torque to the drum 130, the drum 130 may be rotated in a first or forward direction, and thus, the laundry in the drum 130 may be rotated in the first direction, step S210. The first directional torque may be a forward or CW directional torque and the first direction may be a forward or CW direction. When the driving device 140 applies the first directional torque to the drum 130 in which the laundry is placed at a bottom thereof, the drum 130 may be rotated in the first direction. When the drum 130 is rotated in the first direction, the laundry may be lifted by the lifter 135 and rotated in the first direction. The drum 130 may be rotated at about 60 rpm, which is over 1 G, so that the laundry is rotated, sticking to the drum 130 during rotation of the drum 130. The driving device 140 applies the first directional torque to rotate the drum 130 greater than 120° so that laundry in the drum is rotated in the first direction and lifted. The driving device 140 may apply the first directional torque to rotate the drum 130 approximately 180°.

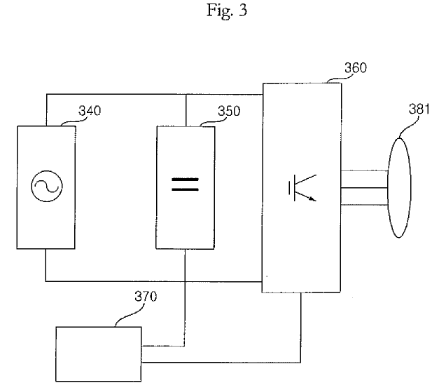

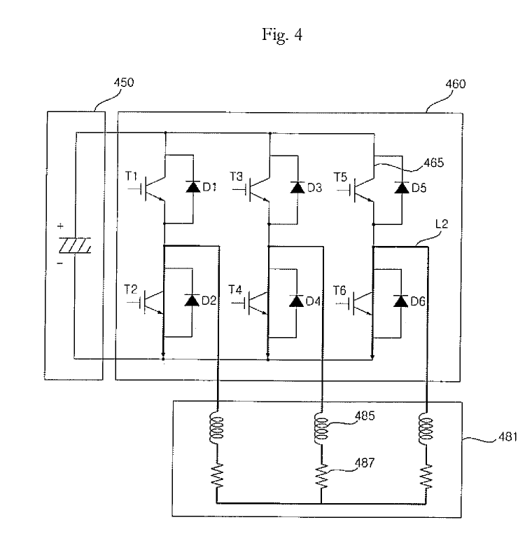

When the laundry is lifted to a maximum height greater than half a height of the drum 130, the driving device 140 may brake the drum 130 to reduce the rotational speed of the drum 130, in step S220. When the laundry is lifted above approximately 165° as the drum 130 is rotated in the first direction, the driving device 140 may brake the drum 130. The driving device 140 may brake the drum 130 by negative-phase or dynamic braking. The negative-phase or dynamic braking will be described in detail later with reference to FIGS. 3 and 4.

While the driving device 140 brakes the drum 130, the laundry may be dropped, in step S230. As the driving device 140 brakes the drum 130, the rotation of the drum 130 may be temporarily stopped and, at this time, the laundry may be dropped. The laundry may be dropped at an angle of about 180° to maximize an amount of impact. Moreover, at least a portion of the laundry may be dropped, passing through a central longitudinal axis of the drum 130.

When the driving device 140 applies a second directional torque to the drum 130 after the laundry is dropped, the drum 130 may be rotated in the second direction, and thus, the laundry in the drum 130 may be rotated in the second direction, in step S240. The second directional torque may be a reverse or counterclockwise (CCW) torque and the second direction may be a reverse or CCW direction. When the driving device 140 applies the second directional torque to the drum 130, the drum may be rotated in the second direction. Then, the laundry may be lifted by the lifter 135 and rotated in the second direction. The drum 130 may be rotated at about 60 rpm, which is over 1 G, so that the laundry is rotated, sticking to the drum 130 during rotation of the drum 130. The driving device 140 applies the second directional torque to rotate the drum 130 greater than 120° so that the dropped laundry is rotated in the second direction and lifted. The driving device 140 may apply the second directional torque to rotate the drum 130 approximately 180°.

When the laundry is rotated in the second direction and lifted to a maximum height greater than half the height of the drum 130, the driving device 140 may brake the drum 130 to reduce the rotational speed of the drum 130, in step S250. When the laundry is lifted above approximately 165° as the drum 130 is rotated in the second direction, the driving device 140 may brake the drum 130. The driving device 140 may brake the drum 130 by negative-phase or dynamic braking. The negative-phase or dynamic braking will be described in detail later with reference to FIGS. 3 and 4.

While the driving device 140 brakes the drum 130, the laundry may be dropped, in step S260. As the driving device 140 may brake the drum 130, the rotation of the drum 130 may be temporarily stopped and, at this time, the laundry may be dropped. The laundry may be dropped at an angle of about 180° to maximize the amount of impact. Moreover, at least a portion of the laundry may be dropped, passing through a central longitudinal axis of the drum 130. After the laundry is dropped, the above-described steps may be repeated, starting from step S210.

FIG. 3 is a diagram illustrating negative-phase braking in a washing method in accordance with an embodiment. The negative-phase braking is configured to drive and stop a motor so that torque is generated in a direction opposite to the direction in which the motor rotates.

A power supply device 340 may supply input AC power, for example AC 220V, rectified by a bridge diode (not shown) and smoothed by a smoothing capacitor (not shown). A DC voltage device 350 may store a DC voltage by charging a capacitor with a voltage supplied from the power supply device 340, and the stored DC voltage may be used to drive a motor 381.

During negative-phase braking, the DC voltage device 350 may apply a voltage having a magnitude corresponding to the speed of the motor 381 to a braking device 360. The braking device 360 may convert the voltage output from the DC voltage device 350 into a reverse voltage having a phase shifted by approximately 180° from that of the voltage being used to drive the motor 381 and supply the same to the motor 381.

FIG. 4 is a diagram illustrating dynamic braking in a washing method in accordance with an embodiment. The dynamic braking is configured to stop a motor by forming a closed circuit in the motor so that an electromotive force generated in the closed circuit is consumed by a resistor.

Referring to FIG. 4, a braking device 460 may include three phases (T1 and T2, T3 and T4, and T5 and T6) connected in parallel, in which each phase may include two switching elements 465, such as a transistor or IGBT, connected in series. During dynamic braking, the braking device 460 may turn on lower switching elements T2, T4, and T6 among the switching elements 465 constituting the braking device 460 and turn off upper switching elements T1, T3, and T5. Thus, a DC voltage device 450 and a motor 481 may be disconnected, and a coil 485, a resistor 487, and the lower switching elements T2, T4, and T6 may form a closed circuit. The motor 481 rotated by an applied voltage may function as an electric generator, and thus, a counter electromotive force may be generated in the coil 485. The generated counter electromotive force may be consumed by the resistor 487 in the motor 481 to brake the motor 481. However, the counter electromotive force may be consumed by a resistor arranged outside the motor 481.

FIGS. 5A-5D are diagrams showing various motions created in a washing machine in accordance with an embodiment. FIG. 5A represents a first motion which is created when the driving device 140 reciprocates the drum 130 in the first and second directions so that the laundry in the drum 130 is lifted to a maximum height greater than half the height of the drum 130 and then dropped. The first motion is created in the same manner as the washing method in accordance with the embodiment described with respect to FIG. 2 and, therefore, its detailed description will be omitted.

FIG. 5B represents a second motion which is created when the driving device 140 continuously applies a first directional torque to the drum 130 to rotate the drum 130 in the first direction so that the laundry in the drum 130 may be lifted and then dropped. When the driving device 140 applies the first directional torque to the drum 130, the drum may be rotated in the first direction. As the drum is rotated in the first direction, the laundry may be repeatedly lifted and dropped.

In the case in which the drum 130 is rotated at about 45 rpm, which corresponds to 1 G, the laundry in the drum 130 may be lifted to a maximum height greater than half a height of the drum 130 and then dropped. In the case in which the drum 130 is rotated at less than about 40 rpm, the laundry in the drum 130 may be lifted to a maximum height less than half the height of the drum 130 and then tumbled.

FIG. 5C represents a third motion which is created when the driving device 140 reciprocates the drum 130 in the first and second directions so that the laundry in the drum 130 is lifted to a maximum height less than half the height of the drum 130 and then dropped. The third motion is similar to the first motion; however, in this case, the rotational speed of the drum 130 may not exceed approximately 40 rpm so that the laundry in the drum 130 may be lifted to a maximum height less than half the height of the drum 130 and then tumbled.

FIG. 5D represents a fourth motion which is created when the driving device 140 applies a first directional torque to the drum 130, brakes the drum 130, and then applies the first directional torque to the drum 130 again so that the drum 130 is rotated in the first direction. In the fourth motion, when the driving device 140 applies the first directional torque to the drum 130, the laundry in the drum 130 may be rotated, sticking to the drum 130, and lifted during rotation of the drum 130 and then dropped when the drum 130 is braked. Then, when the driving device 140 again applies the first directional torque to the drum 130, the dropped laundry is rotated, sticking to the drum 130, and lifted again during rotation of the drum 130. The drum 130 may be rotated at about 60 rpm, which is over 1 G, so that the laundry is rotated, sticking to the drum 130 during rotation of the drum 130.

In general, a washing course may include a washing cycle, in which fluid, such as water, mixed with detergent may be supplied to the tub 120 and then the drum 130 operated, a rinsing cycle, in which fluid, such as water, with no detergent may be supplied to the tub 120 and then the drum 130 operated, and a dehydrating cycle, in which the drum 130 may be operated so that fluid in the laundry is removed. The controller 115 may perform the above-described respective motions appropriately in the washing cycle or rinsing cycle.

In the case in which an amount of the laundry is large, the first and second motions may be appropriately repeated. In this case, the second motion may be performed at about 45 rpm so that the laundry may be lifted to a maximum height greater than half the height of the drum 130 and then dropped. Moreover, the duration of the second motion may be longer than that of the first motion.

In the case in which the amount of the laundry is small, the first and fourth motions may be appropriately repeated. In this case, the second motion may be appropriately performed during that process. Moreover, the duration of the first motion may be longer than that of the fourth motion.

In the case in which the laundry may be easily damaged or the washing process performed near midnight, the third motion may be mainly performed.

Further, the second and third motions may be appropriately repeated according to an amount of wash fluid in the rinsing cycle.

Accordingly, the washing machine and washing method therefor according to embodiments disclosed herein provide at least one of the following advantages.

First, the amount of impact may be increased when the laundry is dropped, thus improving washing performance. Second, the washing performance may be improved while minimizing damage to the laundry. Third, various motions may be performed according to a type of laundry during washing or rinsing cycles. Finally, wear and tear of the parts and heat generation by performing effective braking may be minimized.

Embodiments disclosed herein provide a washing machine and washing method therefor that improve washing performance. Embodiments disclosed herein further provide a washing machine and washing method therefor that may minimize damage to laundry and maximize an amount of impact when the laundry is dropped in a drum.

Embodiments disclosed herein provide a washing method that may include: (a) applying a first directional or forward torque to a drum so that laundry in the drum is rotated in a first or forward direction and lifted to a maximum height greater than half a height of the drum; (b) braking the drum so that the laundry is dropped; (c) applying a second directional or reverse torque to the drum so that the dropped laundry is rotated in a second or reverse direction and lifted to a maximum height greater than half a height of the drum; and (d) braking the drum so that the laundry is dropped.

Embodiments disclosed herein further provide a washing method that may include: (p) rotating a drum in a first or forward direction so that laundry in the drum is lifted to a maximum height greater than half the height of the drum; (q) reducing the rotational speed of the drum so that the laundry is dropped; (r) rotating the drum in a second or reverse direction so that the dropped laundry is lifted to a maximum height greater than half the height of the drum; and (s) reducing the rotational speed of the drum so that the laundry is dropped.

Additionally, embodiments disclosed herein provide a washing method, in which a drum is reciprocated in a first or forward and second or reverse direction that may include: (w) applying a first directional or forward torque to the drum to be rotated in the first or forward direction; (x) braking the drum to be temporarily stopped before the drum is rotated in the first or forward direction once; (y) applying a second directional or reverse torque to the drum to be rotated in the second or reverse direction; and (z) braking the drum to be temporarily stopped before the drum is rotated in the second or reverse direction once.

Embodiments disclosed herein also provide a washing method that may include: (a′) applying a first directional or forward torque to a drum while laundry in the drum is rotated in a first or forward direction to a maximum height less than half a height of the drum; (b′) braking the drum while the laundry is rotated in the first or forward direction to a maximum height greater than half the height of the drum; (c′) applying a second directional or reverse torque to the drum while the laundry is rotated in the second or reverse direction to a maximum height less than half the height of the drum; and (d′) braking the drum while the laundry is rotated in the second or reverse direction to a maximum height greater than half the height of the drum.

Embodiments disclosed herein further provide a washing machine that may include: a drum that accommodates laundry and which is rotated; a driving unit or device that rotates the drum by applying torque thereto; and a control unit or controller that provides a first motion in which the driving unit reciprocates the drum in a first or forward and a second or reverse direction so that the laundry in the drum is lifted to a maximum height greater than half a height of the drum and then dropped, and a second motion in which the driving unit rotates the drum in the forward direction once by continuously applying forward torque to the drum so that the laundry in the drum is lifted and then dropped.

Embodiments disclosed herein further provide a washing machine that may include: a drum that accommodates laundry and which is rotated; a driving unit or device that rotates the drum by applying torque thereto; and a control unit or controller that provides a first motion in which the driving unit reciprocates the drum in a first or forward and a second or reverse direction so that the laundry in the drum is lifted to a maximum height greater than half a height of the drum and then dropped, and a third motion in which the driving unit reciprocates the drum in the first or forward and second or reverse directions so that the laundry in the drum is lifted to a maximum height less than half the height of the drum and then dropped.

Embodiments disclosed herein additionally provide a washing machine that may include: a drum that accommodates laundry and which is rotated; a driving unit or device that rotates the drum by applying torque thereto; and a control unit or controller that provides a first motion in which the driving unit reciprocates the drum in a first or forward and a second or reverse direction so that the laundry in the drum is lifted to a maximum height greater than half a height of the drum and then dropped, and a fourth motion in which the driving unit rotates the drum in the first or forward direction once by applying a first directional or forward torque to the drum, braking the drum, and then again applying the first directional or forward torque to the drum.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A washing method for a washing machine, comprising:
applying a first directional torque to rotate a drum greater than 120° so that laundry in the drum is rotated in a first direction and lifted;
braking the drum so that the laundry is dropped;
applying a second directional torque, which is a reverse of the first directional torque, to rotate the drum greater than 120° so that the dropped laundry is rotated in a second direction and lifted; and
braking the drum so that the laundry is dropped.

2. The washing method of claim 1, wherein the braking of the drum is accomplished by the application of the second directional torque.

3. The washing method of claim 1, wherein the applying the first directional torque to rotate the drum greater than 120° comprises applying the first directional torque to rotate the drum greater than 120° so that the laundry in the drum is rotated in the first direction and lifted to a maximum height greater than half a height of the drum, and the applying the second directional torque to rotate the drum greater than 120° comprises applying the second directional torque to rotate the drum greater than 120° so that the dropped laundry is rotated in the second direction and lifted to a maximum height greater than half the height of the drum.

4. The washing method of claim 1, wherein the applying the first directional torque to rotate the drum greater than 120° comprises applying the first directional torque to rotate the drum greater than approximately 150° so that the laundry in the drum is rotated in the first direction and lifted, and applying the second directional torque to rotate the drum greater than 120° comprises applying the second directional torque to rotate the drum greater than approximately 150° so that the dropped laundry is rotated in the second direction and lifted.

5. The washing method of claim 1, wherein the applying the first directional torque to rotate the drum greater than 120° comprises applying the first directional torque to rotate the drum approximately 180° so that laundry in the drum is rotated in the first direction and lifted, and applying the second directional torque to rotate the drum greater than 120° comprises applying the second directional torque to rotate the drum greater than approximately 180° so that the dropped laundry is rotated in the second direction and lifted.

6. The washing method of claim 1, wherein, in at least one of the first and second braking, at least a portion of the laundry is dropped, passing through a central longitudinal axis of the drum.

7. The washing method of claim 1, wherein, in the first braking, the second directional torque is applied to the drum and, in the second braking, the first directional torque is applied to the drum.

8. The washing method of claim 1, wherein, in the first and second braking, an electromotive force generated in a closed circuit formed in a motor of a driving device that rotates the drum is consumed by a resistor to brake the drum.

9. The washing method of claim 1, wherein the washing method is performed in a wash cycle or a rinse cycle of the washing machine.

10. The washing method of claim 1, wherein the washing machine comprises a front loading washing machine.

11. A washing method for a washing machine, comprising:
rotating a drum greater than 120° in a first direction so that laundry in the drum is lifted;
reducing a rotational speed of the drum so that the laundry is dropped;
rotating the drum greater than 120° in a second direction, which is a reverse of the first direction, so that the dropped laundry is lifted; and
again reducing the rotational speed of the drum so that the laundry is dropped.

12. A washing method for a washing machine, comprising:
applying a first directional torque to rotate a drum greater than 120° in a first direction;
braking the drum;
applying a second directional torque, which is a reverse of the first directional torque, to rotate the drum greater than 120° in a second direction; and
again braking the drum.

13. A washing machine, comprising:
a drum that accommodates laundry;
a driving device that rotates the drum by applying torque thereto; and
a controller that controls the driving device to provide a first motion to the drum by applying a first directional torque to rotate the drum greater than 120° so that laundry in the drum is rotated in a first direction and lifted, braking the drum so that the laundry is dropped, applying a second directional torque, which is a reverse of the first directional torque, to rotate the drum greater than 120° so that the dropped laundry is rotated in a second direction and lifted, and again braking the drum so that the laundry is dropped, and a second motion in which the driving device rotates the drum in the first direction by continuously applying the first directional torque to the drum so that the laundry in the drum is lifted and then dropped.

14. The washing machine of claim 13, wherein the controller applies the first directional torque to rotate the drum greater than 120° so that the laundry in the drum is rotated in the first direction and lifted to a maximum height greater than half a height of the drum, and the applies the second directional torque to rotate the drum greater than 120° so that the dropped laundry is rotated in the second direction and lifted to a maximum height greater than half the height of the drum.

15. The washing machine of claim 13, wherein the controller applies the first directional torque to rotate the drum greater than approximately 150° in the first direction, and applies the second directional torque to the drum to rotate the drum greater than approximately 150° in the second direction.

16. The washing machine of claim 13, wherein the controller applies the first directional torque to rotate the drum approximately 180° in the first direction, and applies the second directional torque to rotate the drum approximately 180° in the second direction.

17. The washing machine of claim 13, wherein the driving device rotates the drum at greater than approximately 60 RPM.

18. The washing machine of claim 13, wherein the first and second motions are performed at least once in a washing or rinsing cycle.

19. The washing machine of claim 13, wherein the washing machine is a front loading washing machine.

20. A washing machine, comprising:
a drum that accommodates laundry;
a driving device that rotates the drum by applying torque thereto; and
a controller that controls the driving device to provide a first motion to the drum by applying a first directional torque to rotate a drum greater than 120° so that laundry in the drum is rotated in a first direction and lifted, braking the drum so that the laundry is dropped, applying a second directional torque, which is a reverse of the first directional torque, to rotate the drum greater than 120° so that the dropped laundry is rotated in a second direction and lifted, and again braking the drum so that the laundry is dropped, and a second motion in which the driving device reciprocates the drum in the first and second directions so that the laundry in the drum is lifted to a maximum height less than half a height of the drum and then dropped.

21. A washing machine, comprising:
a drum that accommodates laundry;
a driving device that rotates the drum by applying torque thereto; and
a controller that controls the driving device to provide a first motion to the drum by applying a first directional torque to rotate the drum greater than 120° so that laundry in the drum is rotated in a first direction and lifted, braking the drum so that the laundry is dropped, applying a second directional torque, which is a reverse of the first directional torque, to rotate the drum greater than 120° so that the dropped laundry is rotated in a second direction and lifted, and again braking the drum so that the laundry is dropped, and a second motion in which the driving device rotates the drum in the first direction by applying the first directional torque to the drum, braking the drum, and then again applying the first directional torque to the drum.
